(19) United States
(12) Patent Application Publication
(10) Pub. No.: US 2002/0194738 A1
(43) Pub. Date: Dec. 26, 2002

(54) Device for guiding the cutting edge of a knife or the like

(76) Inventor: Antonio Assis Francisco, Sao Sebastiao (BR)

Correspondence Address: Richard L. Byrne, WEBB ZIESENHEIM LOGSDON ORKIN & HANSON, P.C., 700 Koppers Building, 436 Seventh Avenue, Pittsburgh, PA, 15219-1818, US

(21) Appl. No.: 10/133,218

(22) Filed: Apr. 26, 2002

(30) Foreign Application Priority Data
Apr. 26, 2001 (BR) PI 0101890-6

(51) Int. Cl. B26B 29/02

(52) U.S. Cl. 30/291; 30/289; 30/296.1; 30/298

(57) ABSTRACT

The present invention refers to a device for guiding the cutting edge of a knife or the like, particularly designed to facilitate the handling and cutting of foodstuff having a substantially flat configuration such as sandwiches, tortillas and others in order to allow for a simple, easy and hygienic cutting of the food. The device includes an elongated body having a base portion and a handle portion projecting upwardly from the base portion, and is trespassed by at least one slit, said slit being sufficiently wide to receive the cutting blade of a knife or the like in its interior and opening to the bottom surface of said base portion to allow the cutting of the food.

### BACKGROUND OF THE INVENTION

1. Field of the Invention

The present invention refers to kitchen utensils in general and, more specifically, to a device for guiding the cutting edge of a knife or the like particularly designed to facilitate the handling and cutting of foodstuff having a substantially flat configuration such as sandwiches, tortillas and others in order to allow for a simple, easy and hygienic cutting of the food.

2. Description of the Prior Art

As it is widely known in the state of the art, a major problem involved in preparing food, whether in a domestic environment at home, for family consumption, or in a restaurant for the consumption of the general public, is the maintenance of minimal hygienic conditions not only of the very place where the food is being prepared but also, mainly, of the hands of the persons working with and preparing the food, and of the utensils used for preparing the food.

Nevertheless, notwithstanding the concern of the people involved in preparing food regarding maintaining minimum hygienic conditions, the preparation of food served over the counter in bars, restaurant tables, kiosks and other similar places, and sometimes even at home, rarely meets said desired minimum and standard hygienic conditions.

Actually, restaurants, bars, kiosks and similar places where food is prepared where the persons involved in preparing the food wear special gloves or other means to avoid direct hand and clothes contact with the food being prepared are very rare to be found, mainly when said food is a sandwich or the like.

The most usual manner to prepare and to serve a sandwich or the like can be described with very few words and, unfortunately, while these words illustrate a complete disregard for hygienic conditions, they also illustrate a most common attitude to many people.

For preparing a sandwich, typically the ingredients are cut and heated, should that be necessary, like for a hot sandwich, and immediately afterwards the sandwich is prepared with said ingredients being placed over a slice of bread and transported to a serving dish or a cutting board with the help of a spatula, to be cut in two or more parts. Typically, to carry out such cutting, the person will hold the sandwich with one hand and will cut it with a spatula or a knife held by the other hand.

This operation, for being so customary, may pass unnoticed to a great number of people, but it unmistakably symbolizes a complete lack of hygiene from the person preparing the sandwich.

Effectively, when the hands are placed in direct contact with the bread or other ingredients of the sandwich, it allows for the transfer of dirt and any bacteria adhered to the skin, that is transferred to the sandwich and, eventually, may cause contamination and food poisoning.

Some people involved in preparing food who worry a little bit more about the cleanness and the hygiene of the food being prepared will use paper serviettes or napkins to hold the sandwich in order to be able to cut it, but the great majority avoid wearing gloves claiming they limit their movements and interfere with the handling of the food.

Also, with particular reference to paper napkins or serviettes, some establishments owners view the continuous use of discarding paper serviettes for this purpose as an additional cost to be avoided, thereby they give preference to the previous and habitual process, that is to say, keeping the hand contact with the food.

### SUMMARY OF THE INVENTION

Therefore, an object of the present invention is to provide means to allow the handling and cutting of food in a totally hygienic manner, particularly suitable for cutting sandwiches and other foodstuffs having a substantially flat configuration which will avoid altogether any contact of the hands of the person preparing the food.

An additional object of the present invention is to provide means to allow the handling and cutting of food in a totally hygienic manner without forcing the people preparing the food to wear gloves or any other article that limits their movements and/or generate additional costs to the establishment.

According to the present invention, the above objectives are accomplished by the provision of a device for guiding the cutting edge of a knife or the like, particularly designed to allow for cutting foodstuff having a substantially flat configuration, said device comprising an elongated body having a lower pedestal portion and an upper handle portion projecting upwardly from said pedestal portion, said body being formed with at least one, preferably two, trespassing slits, said slits being sufficiently wide to receive a cutting tool like a knife or similar in its interior and opening to the bottom surface of said pedestal portion.

Additional objects and advantages of the invention are set forth in part in the description which follows and in part are obvious from the description, or may be learned from the practice of the invention. The objects and advantages of the invention also may be realized and attained by means of the features particularly pointed out in the attached claims.

### BRIEF DESCRIPTION OF THE DRAWINGS

The accompanying drawings, which are incorporated in and constitute a part of the specification, illustrate preferred embodiments of the invention, and together with the description serve to explain the principles of the invention. In the drawings:

FIG. 1 is a perspective view of a first preferred embodiment of the device for guiding the cutting edge of a knife or the like according to the present invention;

FIG. 2 is a perspective view of a second embodiment of the device for guiding the cutting edge of a knife or the like according to the present invention;

FIGS. 3, 4 and 5 are top plan views illustrating possible constructive variations of the device for guiding the cutting edge of a knife or the like according to the present invention; and

FIG. 6 is an elevation sectional view of the device shown in FIG. 3 taken along the cutting lines indicated in said Figure.

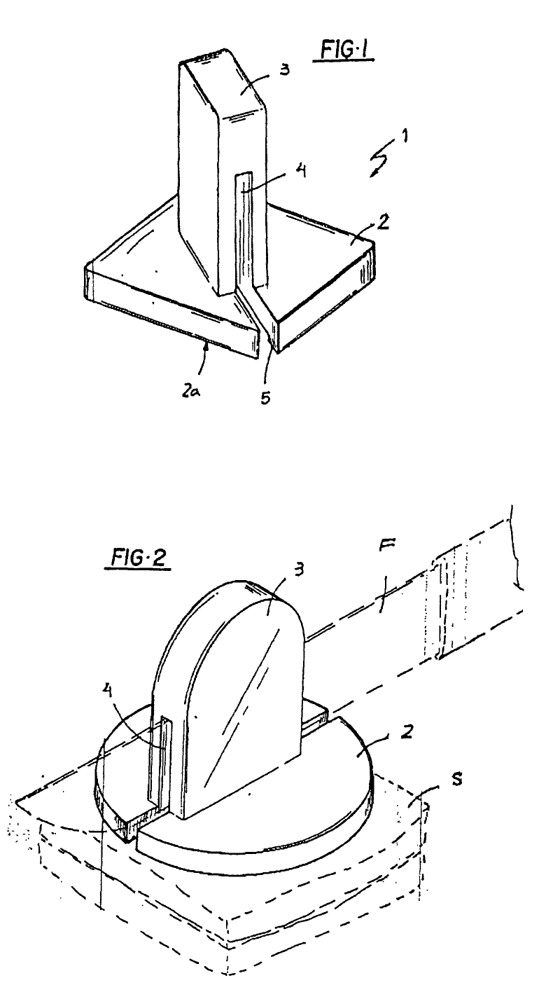

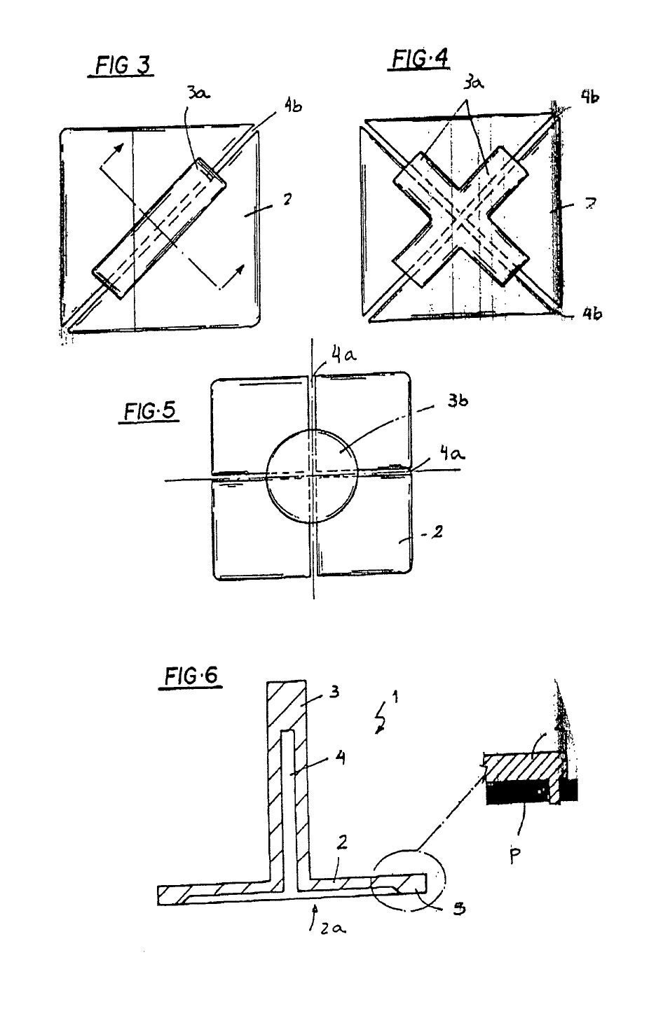

### DESCRIPTION OF A PREFERRED EMBODIMENT

Specific embodiments of the actually preferred present invention are illustrated as examples in the attached drawings and will be further described in detail hereinafter. However, it should be understood that while the present invention is susceptible to several modifications and alterations of configuration and dimensions, the purpose of the present specification is not to limit the invention to the particular forms and/or dimensions described herein but, instead, to cover all the modifications and alternative embodiments that are within the spirit and scope of the invention, as defined by the attached claims.

With particular reference now to the drawings, the object of the present invention is a device for guiding the cutting edge of a knife or the like, particularly designed to allow for the cutting of foodstuff having a substantially flat configuration, said device comprising a vertically elongated body 1 having a lower pedestal portion 2 and a handle portion 3 projecting upwardly from said pedestal portion 2.

The body 1 has at least one trespassing slit 4 cut therethrough, said slit passing through a lower part of said handle portion 3 and through said pedestal portion 2, The slit 4 is sufficiently wide to receive the cutting blade F of cutting tool like a knife or the like in its interior and opens to the bottom surface 2a of said pedestal portion 2.

The pedestal portion 2 is substantially horizontal and defines a bottom surface 2a for contacting the foodstuff and an upper surface 2b from which the handle portion 3 projects upwardly.

The bottom surface 2a can also be substantially horizontal or, preferably, it can have a substantially concave configuration, as shown in FIG. 6, where said bottom surface 2a is surrounded by a peripheral lip 5 which main function is to further reduce the contact of the device with the foodstuff.

Other preferred configurations for said bottom surface 2a include providing a plurality of small grooves or ridges defining elevated areas (not shown) thereon for the same purpose of maintaining a minimum contact between the device and the food.

In one particularly preferred embodiment, said bottom surface 2a is coated with a plastic film P or similar, for wrapping the foodstuff.

As shown in the drawings, said pedestal portion 2 may have a substantially square or circular horizontal cross section, and said handle portion 3 may have a similar or a different horizontal cross section.

Additionally, said trespassing slit 4 may be transversally 4a or diagonally 4b positioned in said body 1, and when more than one slit is provided, they may intersect each other perpendicularly.

Preferably, said elongated body 1 is an integral body, manufactured from any material having suitable features of strength and hardness, such as a rigid plastic, wood, stainless steel or the alike.

As it will be described hereinafter, the device for guiding the cutting edge of a knife or the like according to the present invention is very simple to use.

Once the sandwich or foodstuff is prepared, said sandwich or foodstuff is transferred to an adequate support such as a serving dish or the like, and the bottom surface 2a of the pedestal portion 2 is placed over the sandwich.

The handle portion 3 helps the person using the device according to the present invention to apply a slight pressure on the sandwich, to maintain it in a steady position, and the cutting blade of a knife or the like is inserted through one end of slit 4, to cut the sandwich in two without any need whatsoever of the person doing the cutting touching the sandwich.

Therefore, what actually has any contact with the foodstuff it is only the bottom face of the device for guiding the cutting edge of the knife and the cutting knife, therefore eliminating any possibility of manual contact of the individual.

Having described and illustrated what is considered the best form actually contemplated for embodying the present invention, various modifications variations in its form of manufacture may be promptly apparent to those skilled in the art. Therefore, it is to be understood that the present invention is not limited to the practical aspects of the actual preferred embodiments hereby illustrated and described, and that any such modifications and variations must be considered as being within the spirit and the scope of the invention, as described in the attached claims.

What is claimed is:

1. A device for guiding the cutting edge of a knife or the like, particularly designed for cutting foodstuff having a substantially flat configuration, comprising a body having a lower pedestal portion and a handle portion projecting upwardly from said pedestal portion, and having at least one trespassing opening being sufficiently wide enough to receive a cutting instrument in like a knife or similar in its interior and opening to the bottom surface of said pedestal portion.

2. The device for guiding the cutting edge of a knife or the like according to claim 1, wherein said pedestal portion has a substantially horizontal bottom surface for contacting the foodstuff and an upper surface from which said handle portion projects.

3. The device for guiding the cutting edge of a knife or the like according to claim 2, wherein the bottom surface of the lower pedestal portion is substantially horizontal.

4. The device for guiding the cutting edge of a knife or the like according to claim 2, wherein the bottom surface of the lower pedestal portion is substantially concave.

5. The device for guiding the cutting edge of a knife or the like according to claim 3, wherein the bottom surface of the lower pedestal portion is surrounded by a peripheral lip.

6. The device for guiding the cutting edge of a knife or the like according to claim 4, wherein the bottom surface of the lower pedestal portion is surrounded by a peripheral lip.

7. The device for guiding the cutting edge of a knife or the like according to claim 5, wherein the bottom surface of the lower pedestal portion is formed with a plurality with grooves.

8. The device for guiding the cutting edge of a knife or the like according to claim 5, wherein the bottom surface of the lower pedestal portion is formed with a plurality with ridges.

9. The device for guiding the cutting edge of a knife or the like according to claim 5, wherein the bottom surface of the lower pedestal portion is coated with a plastic film.

10. The device for guiding the cutting edge of a knife or the like according to claim 7, wherein the bottom surface of the lower pedestal portion has a substantially square horizontal cross section.

11. The device for guiding the cutting edge of a knife or the like according to claim 8, wherein the bottom surface of the lower pedestal portion has a substantially square horizontal cross section.

12. The device for guiding the cutting edge of a knife or the like according to claim 9, wherein the bottom surface of the lower pedestal portion has a substantially square horizontal cross section.

13. The device for guiding the cutting edge of a knife or the like according to claim 7, wherein the bottom surface of the lower pedestal portion has a substantially circular horizontal cross section.

14. The device for guiding the cutting edge of a knife or the like according to claim 8, wherein the bottom surface of the lower pedestal portion has a substantially circular horizontal cross section.

15. The device for guiding the cutting edge of a knife or the like according to claim 9, wherein the bottom surface of the lower pedestal portion has a substantially circular horizontal cross section.

16. The device for guiding the cutting edge of a knife or the like according to claim 1, wherein the handle portion has a substantially square horizontal cross section.

17. The device for guiding the cutting edge of a knife or the like according to claim 1, wherein the handle portion has a substantially circular horizontal cross section.

18. The device for guiding the cutting edge of a knife or the like according to claim 10, wherein said at least one trespassing opening is diagonally formed in the bottom portion of the lower pedestal portion.

19. The device for guiding the cutting edge of a knife or the like according to claim 13, wherein said at least one trespassing opening is positioned along a diameter of the bottom portion of the lower pedestal portion.

20. The device for guiding the cutting edge of a knife or the like according to claim 1, wherein said body is integrally formed.

21. The device for guiding the cutting edge of a knife or the like according to claim 1, wherein said body is manufactured from a hardened material such as hard or rigid plastic, wood or stainless steel.
